(19) United States
(12) Patent Application Publication
(10) Pub. No.: US 2016/0037804 A1
(43) Pub. Date: Feb. 11, 2016

(54) COMPOSITION COMPRISING A SOYA DERIVATIVE AND VITAMINS FOR USE IN ANIMAL NUTRITION

(71) Applicant: SEVECOM S.P.A., Milano (IT)

(72) Inventor: Nazzaro SERINO, Milano (IT)

(21) Appl. No.: 14/649,523

(22) PCT Filed: Dec. 6, 2013
(86) PCT No.: PCT/IB2013/002702

§ 371 Date: Jun. 3, 2015

(30) Foreign Application Priority Data
Dec. 7, 2012 (IT) MI2012A002091

(51) Int. Cl. A23K 1/16

(52) U.S. Cl. CPC A23K 1/1603; A23K 1/164

(57) ABSTRACT

A liquid composition including a soya derivative and at least a vitamin for use in animal nutrition is described. The liquid composition includes ethoxylated fatty acids derived from soya oil or E487 combined with at least a vitamin, preferably at least a fat-soluble vitamin.

The present invention relates to a liquid composition comprising a soya derivative and at least a vitamin for use in animal nutrition. In particular, the present invention relates to a liquid composition comprising ethoxylated fatty acids derived from soya oil or E487 combined with at least a vitamin, preferably at least a fat-soluble vitamin.

The importance that nowadays a proper vitamin intake has in animal nutrition is well known. In particular, fat-soluble vitamins are known to be the most important to be administered to the animals and, thus, to be continuously supplemented in their diet.

For this reason some vitamin-based formulations have been introduced in the market, but they are not devoid of drawbacks.

A first drawback is that the existing formulations are not time-stable.

The instability of a liquid formulation comprising water and fat-soluble vitamins leads to a first layering of vitamins relative to the aqueous phase and/or to a color change. In some cases, an actual physical separation of the vitamins themselves from the aqueous phase occurs, whereby the formulation cannot be effectively used. A poor or reduced stability also leads to a reduced shelf-life causing drawbacks to the end-users.

Accordingly, there is a need for having time-stable liquid formulations, which do not give rise to separation and/or layering phenomena of vitamins.

A second drawback is that the formulations currently marketed are not clear and transparent. The clearness of a liquid formulation containing water and vitamins seems to be a feature strongly related to the stability thereof. Furthermore, the market demands stable and clear liquid formulations due to the fact that they are more attractive relative to formulations having a brown or darkened or brownish color.

Thus, there is a need for having clear and stable liquid formulations. Furthermore, there is a need to have liquid formulations each containing a single vitamin so that a liquid formulation containing, for example, vitamin A could be mixed or dosed with another liquid formulation containing, for example, vitamin E. This easiness of mixing the various liquid formulations allows to dosing several vitamins together in an animal feed and/or in the drinking water.

A third drawback is that the existing formulations have a water content not greater than 10% by weight. These formulations present a too high vitamin content. A high concentration leads to a more difficult handling of the product use and the dosage thereof is not always easy during its use.

Therefore, there is a need for having formulations with a water content as high as possible and, in any case, greater than 10% by weight.

Finally, every fat-soluble vitamin is known to have a different behavior in water from each other since each fat-soluble vitamin differs from each other by the intrinsic chemical and/or physical properties. Every vitamin has a typical behavior in water.

Thus, a further drawback is that, to date, a preparation method, which could be indiscriminately applied to all the fat-soluble vitamins does not exist. This causes that the preparation methods should take into account, case-by-case the chemical and/or physical properties of each fat-soluble vitamin and modify the preparation method by using specific operating expedients.

Therefore, there is still a need for having a preparation method which can be indiscriminately applied to all the fat-soluble vitamins and which is an easy, inexpensive method capable to prepare stable, clear liquid formulations of fat-soluble vitamins and with a high water content.

Following to an intensive research activity, the Applicant answered to the above-cited needs.

The Applicant found and refined a method for preparing a liquid composition comprising water and at least a fat-soluble vitamin devoid of the limits of the formulations of the known art.

The liquid composition herein proposed may be suitably used in the animal nutrition as such, for example by adding it directly to an animal feed, or the liquid composition can be added to an animal feed during the preparation thereof, for example by spraying or sprinkling the liquid composition over the feed, or the liquid composition can be added to the animal drinking water.

The Applicant has surprisingly found that the above aims, and further aims which will be evident from the following detailed description, are achieved by using a soya derivative in a method for preparing the liquid composition further comprising water and at least a fat-soluble vitamin.

The liquid composition comprises or, alternatively, consists of a soya derivative (a) selected from the group comprising or, alternatively, consisting of:
polyethyleneglycol esters of fatty acids derived from soya oil-additive E487, also referred to as, for the sake of brevity, (a0),
a soya oil, also referred to as, for the sake of brevity, (a1),
an ethoxylated soya oil and/or an ethoxylated soya, also referred to as, for the sake of brevity, (a2),
at least a fatty acid derived from soya oil, also referred to as, for the sake of brevity, (a3),
at least an ethoxylated fatty acid derived from soya oil, also referred to as, for the sake of brevity, (a4), or
mixtures thereof, also referred to as, for the sake of brevity, (a6),

combined with at least a fat-soluble vitamin (b) selected from the group comprising or, alternatively, consisting of vitamin A (in all its forms), vitamin D (in all its forms), vitamin D₃, (in all its forms), vitamin E (in all its forms) and vitamin K (in all its forms) or mixtures thereof, and water.

The liquid composition of the present invention is stable and has a water content greater than 10%; the water content is greater than 15%. The water content is comprised from 20 to 40%, preferably from 25 to 35% of water, relative to the amount by weight of the final liquid composition.

It is an object of the present invention a liquid composition, having the characteristics as defined in the claim unit.

It is an object of the present invention a method for preparing said liquid composition, having the characteristics as defined in the claim unit.

It is an object of the present invention the use of said liquid composition in the animal nutrition, having the characteristics as defined in the claim unit.

Preferred embodiments of the present invention are described and/or claimed below.

Hereinafter in the present specification vitamins could be denoted, for the sake of brevity, without altering their meaning, in the following way: vitamin A could also be referred to as (b1), vitamin D or D₃ could also be referred to as (b2), vitamin E could also be referred to as (b3) and vitamin K could also be referred to as (b4).

Hereinafter in the present invention the fat-soluble vitamins could also be in a mixture with soluble vitamins. The water-soluble vitamins are selected from: vitamin A (retinol and analogues), vitamin D (ergocalciferol D₂ and cholecalciferol D₃), vitamin E (naphthoquinone and derivatives), vitamin F (linoleic) and vitamin Q (ubiquinone). The soluble vitamins which can be in a mixture with the fat-soluble vitamins are selected from: vitamin B1, vitamin B2, vitamin B3, vitamin B5, vitamin B6, vitamin B8, vitamin B9, vitamin B12 and vitamin C. Water-soluble vitamins are at a concentration greater than 90%, preferably greater than 95%, even more preferably greater than 98%.

Hereinafter in the present specification “combined with” means that the compounds constituting the liquid composition are mixed each other.

It is an object of the present invention an animal feed containing said liquid composition comprising or, alternatively, consisting of a soya derivative (a) selected from the group comprising or, alternatively, consisting of (a0), (a1), (a2), (a3), (a4) and/or (a5), combined with at least a fat-soluble vitamin (b) selected from the group comprising or, alternatively, consisting of vitamins referred to as (b1) and/or (b2) and/or (b3) and/or (b4)—hereinafter “at least a fat-soluble vitamin”, and water.

It is a further object of the present invention a process for preparing an animal feed which contemplates the use of said liquid composition comprising or, alternatively, consisting of a soya derivative (a) selected from the group comprising or, alternatively, consisting of (a0), (a1), (a2), (a3), (a4) and/or (a5), combined with at least a vitamin (b) selected from the group comprising or, alternatively, consisting of the vitamins referred to as (b1) and/or (b2) and/or (b3) and/or (b4)—hereinafter “at least a fat-soluble vitamin”, and water.

It is an object of the present invention the use of said liquid composition comprising or, alternatively, consisting of:
a soya derivative (a) selected from the group comprising or, alternatively, consisting of:
polyethyleneglycol esters of fatty acids derived from soya oil-additive E487—(a0),
a soya oil—(a1),
an ethoxylated soya oil and/or an ethoxylated soya—(a2),
at least a fatty acid derived from soya oil—(a3),
at least an ethoxylated fatty acid derived from soya oil—(a4), or
a mixture thereof—(a5); and
at least a fat-soluble vitamin (b) selected from the group comprising or, alternatively, consisting of vitamin A also denoted as (b1), vitamin D or vitamin D₃ also denoted as (b2), vitamin E also denoted as (b3) and vitamin K also denoted as (b4), or
a mixture thereof;

for preparing an animal feed containing liquid, powder or granulated nutrients.

In an embodiment, said composition comprises or, alternatively, consists of: (a0), or (a2), or (a4), or (a5) and at least a fat-soluble vitamin (b) selected from the group comprising or, alternatively, consisting of: vitamin A also referred to as (b1), vitamin D also referred to as (b2), vitamin E also referred to as (b3) and vitamin K also referred to as (b4), or a mixture thereof; and water.

In another embodiment, said composition comprises or, alternatively, consists of: (a0), or (a2) and at least a fat-soluble vitamin (b) selected from the group comprising or, alternatively, consisting of: vitamin A also referred to as (b1), vitamin D also referred to as (b2), vitamin E also referred to as (b3) and vitamin K also referred to as (b4), or a mixture thereof; and water.

Said polyethyleneglycol esters of fatty acids derived from soya oil-additive E487, also generally referred to as, sometimes, ethoxylated soya oil and/or ethoxylated soya, contain from 1 to 200 ethyleneoxy groups; preferably from 10 to 150 ethyleneoxy groups; even more preferably from 20 to 80 ethyleneoxy groups. Advantageously, from 1 to 30, for example 2, or 4, or 6, or 8, or 10, or 12, or 14, or 16, or 18, or 20, or 22, or 24, or 26, or 28, or 30 ethyleneoxy groups (which are to be understood as average ethoxylation values) are contained. These values related to the ethyleneoxy groups have to be considered in the following way: a value of, for example, 10 has to be considered as 10 moles of ethylene oxide (EO) units which, on average, are present in the ethoxylated soya derivative in the form of EO block.

The liquid composition comprises or, alternatively, consists of a soya derivative (a) selected from the group comprising or, alternatively, consisting of (a0) polyethyleneglycol esters of fatty acids derived from soya oil-additive E487, (Community Register of Feed Additives—EU Reg. No. 1831/2003), combined with at least a fat-soluble vitamin (b), and water.

The liquid composition may comprise or consist of: (a0)+(b1); or (a0)+(b2); or (a0)+(b3); or (a0)+(b4) in a weight ratio comprised from 1:5 to 5:1, preferably comprised from 1:3 to 3:1, for example 1:1.

The polyethyleneglycol esters of fatty acids derived from soya oil, (additive E487—EU Reg. 1831/2003) are surfactant or emulsifying compounds approved in the list of additives for animal nutrition (Common Name: PEG esters of fatty acids from soya oil; EC No.: E487; Chemical Name: Polyethyleneglycol ester of fatty acids from soya oil; N. CAS: 61791-07-9).

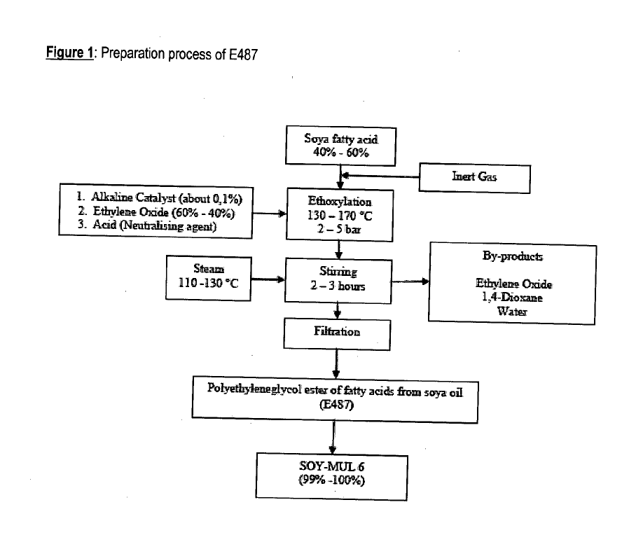

Said esters (a0) are obtained according to techniques, equipment and operating conditions known to the skilled in the field, see FIG. 1. For example, said polyethyleneglycol esters of fatty acids derived from soya oil, (additive E487—EU Reg. 1831/2003) can be obtained from soya oil, for example from soya oil triglycerides which are hydrolyzed, according to techniques and equipment known to the skilled in the field, for yielding saturated and/or unsaturated fatty acids of soya oil. Next, said fatty acids are ethoxylated with ethylene oxide, by known techniques and equipment. The ethylene oxide binds the fatty acid carboxyl group for yielding the fatty acid derived from the ethoxylated soya oil.

For example, said polyethyleneglycol esters of fatty acids derived from soya oil, (additive E487—UE Reg. 1831/2003) can be obtained by reacting a polyethyleneglycol—referred to as, for the sake of brevity, PEG [CAS number 25322-68-3; structural formula HOCH₂—(CH₂—O—CH₂)₍ₙ₋₁₎—CH₂OH or H—(OCH₂—CH₂)ₙ—OH; molecular weight comprised, for example, from 100 to 10000] with fatty acids derived from soya oil or fats or triglycerides of soya oil according to techniques, equipment and operating conditions known to the skilled in the field. Preferably, the polyethyleneglycol (PEG) has a molecular weight comprised from 200 to 5000. Preferably, the polyethyleneglycol has a molecular weight comprised from 300 to 4000; even more preferably from 400 to 3500. In an embodiment, the polyethyleneglycol has a molecular weight comprised from 500 to 1500. In another embodiment, the polyethyleneglycol has a molecular weight comprised from 600 to 1000, for example from 700 to 900.

By fatty acids derived from soya oil is meant one or more fatty acids obtained according to techniques, equipment and operating conditions known to the skilled in the field. For example, a soya oil (triglyceride) can be subjected to a hydrolysis process in water to yield glycerin and a mixture of soya oil fatty acids. The soya fatty acids may be of type S1856, CAS:68308-53-2, EINECS: 269-657-0.

The soya oil (100 g) generally has the following composition: about 16 g of saturated fats, about 23 g of monounsaturated fats, about 58 g of polyunsaturated fats and about 3% of other compounds.

A soya oil, preferably a refined soya oil, contains for example the following fatty acids: linolenic or alpha-linolenic acid (C-18:3)—CAS number 463-40-1, approximately from 5 to 10%; linoleic acid (C-18:2)—CAS number 60-33-3, approximately from 50 to 60%; oleic acid (C-18:1)—CAS number 112-80-1, approximately from 18 to 25%; stearic acid—CAS number 57-11-4, approximately from 3 to 6%; palmitic acid—CAS number 57-10-3, approximately from 8 to 12%.

The polyethyleneglycol esters of fatty acids derived from soya oil of the present invention (additive E487—UE Reg. No. 1831/2003) can be, for example, in the form of monoesters or diesters or mixtures thereof.

In the context of the present invention and hereinafter we will generally refer to “polyethyleneglycol esters of fatty acids derived from soya oil” in order to denote one or more of the above-cited embodiments, having a variable composition of soya oil fatty acids, without any limitation but merely in order to simplify the present description.

The soya oil fatty acid is selected from linolenic or alpha-linolenic acid (C-18:3)—CAS number 463-40-1, or linoleic acid (C-18:2)—CAS number 60-33-3, or oleic acid (C-18:1)—CAS number 112-80-1, or stearic acid—CAS number 57-11-4, or palmitic acid—CAS number 57-10-3 or mixtures thereof; in particular the soya oil fatty acid can be selected from a mixture of linolenic acid and/or linoleic acid and/or oleic acid in a weight ratio of 1:1:1 or 1:1:2 or 1:2:1 or 1:2:2.

The liquid composition comprises or, alternatively, consists of a soya derivative selected from the group comprising or, alternatively, consisting of (a1) soya oil, combined with at least a fat-soluble vitamin (b) and water.

The composition may comprise or consist of: (a1)+(b1); or (a1)+(b2); or (a1)+(b3); or (a1)+(b4); in a weight ratio comprised from 1:5 to 5:1, preferably comprised from 1:3 to 3:1, for example 1:1.

The soya oil is a vegetable oil extracted from soya beans (Glycine max). The soya oil is obtained according to techniques, equipment and operating conditions known to the skilled in the field. The soya oil composition can be, for example, as follows (per 100 grams): 16 grams of saturated fats, 23 grams of monounsaturated fats, 58 grams of polyunsaturated fats and 3% of other compounds. The unsaturated fatty acids occurring in the soya oil triglycerides can be, for example, as follows: 5-10% by weight of alpha-linolenic acid (C-18:3); 50-60% by weight of linoleic acid (C-18:2); and 18-25% by weight of oleic acid (C-18:1). Furthermore, saturated fatty acids such as stearic acid (3-6% by weight) and palmitic acid (8-12% by weight) are also present.

By saturated fat is meant fats consisting of triglycerides only containing saturated fatty acids. Saturated fatty acids have a carbon number comprised, for example, as follows: less than 6 (short-chain saturated fatty acids); from 6 to 12 (medium-chain saturated fatty acids; 13-21 (long-chain saturated fatty acids) and greater than 22 (very long-chain saturated fatty acids).

For example, a soya oil may have the following specifications: an acid value (amount of free fatty acids) less than 0.5 mg KOH/g; a peroxide value not greater than 1.0 meq O₂/Kg; a iodine value comprised from 120 to 145 mg I₂/100 g and a trans fatty acid value of at most 2% by weight.

The liquid composition comprises or, alternatively, consists of a soya derivative selected from the group comprising or, alternatively, consisting of (a2) ethoxylated soya oil and/or ethoxylated soy, in a weight ratio comprised from 1:3 to 3:1, for example 1:1, combined with at least a fat-soluble vitamin (b).

The composition may comprise or consist of: (a2)+(b1); or (a2)+(b2); or (a2)+(b3); or (a2)+(b4); or (ethoxylated soya oil)+(b1); or (ethoxylated soya oil)+(b2); or (ethoxylated soya oil)+(b3); or (ethoxylated soya oil)+(b4); or (ethoxylated soya)+(b1); or (ethoxylated soya)+(b2); or (ethoxylated soya)+(b3); or (ethoxylated soya)+(b4), all of them in a weight ratio comprised from 1:5 to 5:1, preferably comprised from 1:3 to 3:1, for example 1:1.

The ethoxylated soya oil is obtained through an ethoxylation process, which contemplates the use of ethylene oxide, being carried out on the soya oil. The ethoxylation of soya oil is performed by processes, chemical reactions and equipment known to the skilled in the field.

For example an inert gas (nitrogen) is blown in a reactor in order to remove the oxygen being present and, thus, a pre-established amount of soya oil is subsequently introduced in the reactor. A fatty acid pattern in the soya oil can be: C16:0 (palmitic acid) 9-13%; C18:0 (stearic acid) 3-5%; C18:1 (oleic acid) 17-30%; C18: (linoleic acid) 48-58; C18:3 (linolenic acid) 5-10%; C20:0 (arachidonic acid) less than 1%. The soya oil is hydrolyzed to free fatty acids in presence of an alkaline catalyst and ethylene oxide for example at a temperature of 120-180° C. and a pressure of 0.5-6.0 bar. When the addition of ethylene oxide is completed, the reaction temperature is kept until a constant pressure value is reached. The reaction is then cooled down and the alkaline catalyst is neutralized by acid addition. The residual ethylene oxide and 1,4-dioxane are removed by using an inert gas or steam at high temperature. Next, the vacuum is created in order to remove any steam trace (stripping). When the ethylene oxide and 1,4-dioxane levels are of less than 1 mg/Kg and 5 mg/Kg, respectively, the reaction is cooled down under 70° C. and the reaction product filtered.

The ethoxylation degree can vary depending on the needs. For example, 10 or 20 or 40 or 65 moles of ethylene oxide can be reacted with 1 mole of fatty acids contained in the soya oil (see the patent applications GB1050497 A and EP516099 A1 herein incorporated by reference).

The ethoxylated soya is obtained through an ethoxylation process carried out directly on the free saturated and/or unsaturated fatty acids. The free fatty acids are obtained via hydrolysis of soya oil triglycerides. Ethoxylation is an industrial process in which ethylene oxide is added to alcohols, phenols and acids (i.e. compounds with reactive hydrogen atoms) in an amount which varies depending on the operating conditions of temperature, pressure, solvent and catalyst. The ethoxylated soya is obtained through processes, chemical reactions and equipment known to the skilled in the field.

Ethoxylation is also known by the term PEGylation due to the fact that the poly(ethylene oxide) is also known as poly(ethylene glycol), abbreviated PEG. Thus, the ethoxylated soya oil and the ethoxylated soya can be obtained by ethoxylation of soya oil or saturated and/or unsaturated fatty acids derived from soya oil with ethylene oxide, poly(ethylene oxide) or poly(ethylene glycol).

For example, an ethoxylated soya can be prepared according with the process described above for preparing the ethoxylated soya oil. The ethoxylated soya oil or ethoxylated soya contain from 1 to 200 ethyleneoxy groups; preferably from 10 to 150 ethyleneoxy groups; even more preferably from 20 to 80 ethyleneoxy groups.

The ethoxylated soya oil or ethoxylated soya contain from 20 to 80 ethyleneoxy groups, preferably contain from 25 to 60 ethyleneoxy groups. The ethoxylated soya oil or ethoxylated soya contain 40 ethyleneoxy groups. Advantageously, the ethoxylated soya oil or ethoxylated soya contain from 1 to 30, for example from 30 to 45 ethyleneoxy groups. Advantageously, from 1 to 30, for example 2, or 4, or 6, or 8, or 10, or 12, or 14, or 16, or 18, or 20, or 22, or 24, or 26, or 28, or 30 ethyleneoxy groups (which are to be understood as average ethoxylation values) are contained.

By ethoxylated soya containing, for example 40 ethyleneoxy groups (an ethyleneoxy group derives from ethylene oxide), is meant a product obtained by reacting 1 mole of soya oil [the fatty acid composition of soya oil has been set forth above, for the sake of example] with 40 moles of ethylene oxide according to techniques, equipment and operating conditions known to the skilled in the field.

In the context of the present invention and hereinafter we will generally refer to “ethoxylated soya oil” or “ethoxylated soya” for denoting one or more of the above-cited embodiments, having a variable number of ethyleneoxy groups, without any limitation but merely in order to simplify the present specification.

The liquid composition comprises or, alternatively, consists of a soya derivative selected from the group comprising or, alternatively, consisting of (a3) at least a fatty acid derived from soya oil, combined with at least a fat-soluble vitamin (b), and water.

The composition may comprise or consist of: (a3)+(b1); or (a3)+(b2); or (a3)+(b3); or (a3)+(b4), in a weight ratio comprised from 1:5 to 5:1, preferably comprised from 1:3 to 3:1, for example 1:1.

The soya fatty acid can be obtained through a hydrolysis process. The hydrolysis of soya oil triglycerides yields glycerol (or glycerin) and the relative free fatty acids (saturated, monounsaturated and polyunsaturated) such as alpha-linolenic acid, or linolenic acid, or linoleic acid, or oleic acid, or stearic acid, or palmitic acid or a mixture thereof. The mixture may comprise 0-10% by weight of alpha-linolenic acid (C-18:3), preferably from 0 to 5%; 0-70% by weight of linoleic acid (C-18:2), preferably from 40 to 60%; and 0-55% by weight of oleic acid (C-18:1), preferably from 15 to 40%.

In another preferred embodiment, the fatty acid can be a mixture, as disclosed above, which further comprises saturated fatty acids such as stearic acid from 0 to 10% by weight, preferably from 3 to 7% and/or palmitic acid from 0 to 15% by weight, preferably from 5 to 10%.

The liquid composition comprises or, alternatively, consists of a soya derivative selected from the group comprising or, alternatively, consisting of (a4) at least an ethoxylated fatty acid, preferably derived from soya oil, combined with at least a vitamin (b), and water.

The composition may comprise or consist of: (a4)+(b1); or (a4)+(b2); or (a4)+(b3); or (a4)+(b4), in a weight ratio comprised from 1:5 to 5:1, preferably comprised from 1:3 to 3:1, for example 1:1.

Said at least an ethoxylated fatty acid is preferably derived from soya oil, but it can also be obtained from another vegetable oil such as for example olive oil or linseed oil or rapeseed oil or maize oil or peanut oil or sunflower oil or palm oil.

The ethoxylated fatty acid derived from soya oil is obtained by ethoxylation of alpha-linolenic acid, or linolenic acid, or linoleic acid, or oleic acid, or stearic acid, or palmitic acid or a mixture thereof. The mixture subjected to ethoxylation may comprise 0-10% by weight of alpha-linolenic acid (C-18:3), preferably from 0 to 5%; 0-70% by weight of linoleic acid (C-18:2), preferably from 40 to 60%; and 0-55% by weight of oleic acid (C-18:1), preferably from 15 to 40%.

In another preferred embodiment, the mixture being subjected to ethoxylation can be a mixture as disclosed above which further comprises saturated fatty acids such as stearic acid from 0 to 10% by weight, preferably from 3 to 7% and/or palmitic acid from 0 to 15% by weight, preferably from 5 to 10%.

Ethoxylation can be carried out on a triglyceride, a saturated fat, a monounsaturated fat and/or a polyunsaturated fat. The ethoxylation degree varies depending on the operating conditions being used such as, for example temperature, pressure, solvent and catalyst. Thus, the fatty acids derived from soya oil are ethoxylated, by known chemical processes and equipment, to yield the ethoxylated fatty acids of soya oil.

In a preferred embodiment, the ethoxylated fatty acid of soya oil contains from 1 to 200 ethyleneoxy groups; preferably from 10 to 150 ethyleneoxy groups; even more preferably from 15 to 100 ethyleneoxy groups.

In a preferred embodiment, the ethoxylated fatty acid of soya oil contains from 20 to 80 ethyleneoxy groups; preferably from 25 to 60 ethyleneoxy groups; even more preferably from 30 to 50 ethyleneoxy groups. Advantageously, the ethoxylated fatty acid of soya oil contains from 1 to 30, for example from 30 to 45 ethyleneoxy groups, for example 40. Advantageously, from 1 to 30, for example 2, or 4, or 6, or 8, or 10, or 12, or 14, or 16, or 18, or 20, or 22, or 24, or 26, or 28, or 30 ethyleneoxy groups (which are to be understood as average ethoxylation values) are contained.

By ethoxylated fatty acid of soya oil containing, for example 15 ethyleneoxy groups (an ethyleneoxy group derives from ethylene oxide), is meant a product obtained by reacting 1 mole of a single fatty acid or a fatty acid mixture [the soya oil composition has been set forth in the present specification, for the sake of example] with 15 moles of ethylene oxide according to the techniques, equipment and operating conditions known to the skilled in the field. In the context of the present invention and hereinafter we will generally refer to “an ethoxylated fatty acid of soya oil” in order to denote one or more of the above-cited embodiments, having a variable number of ethyleneoxy groups, without any limitation but merely in order to simplify the present description.

The assessment of the fatty acid composition can be carried out by gas chromatography, for example through the method NGD C 42-76. On the other hand, the triglyceride assessment in an oil is carried out by high performance chromatography (HPLC), for example through the method NGD C 45-91:22024 (1992).

The liquid composition comprises or, alternatively, consists of a soya derivative selected from the group comprising or, alternatively, consisting of mixtures (a5), combined with at least a fat-soluble vitamin (b), and water.

The composition may comprise or consist of: (a5)+(b1); or (a5)+(b2); or (a5)+(b3); or (a5)+(b4), in a weight ratio comprised from 1:5 to 5:1, preferably comprised from 1:3 to 3:1, for example 1:1.

The composition comprises or, alternatively, consists of a soya derivative selected from the group comprising or, alternatively, consisting of a mixture (a5)=(a0)+(a1)+(a2), preferably in a weight ratio of 1:1:1, combined with at least a vitamin (b), and water.

The liquid composition comprises or, alternatively, consists of a soya derivative selected from the group comprising or, alternatively, consisting of a mixture (a5)=(a0)+(a1) or (a5)=(a1)+(a2), preferably in a weight ratio of 1:1, combined with at least a fat-soluble vitamin (b), and water.

Said at least a fat-soluble vitamin is selected from the group comprising or, alternatively, consisting of vitamin A—(b1), vitamin D or vitamin D₃—(b2), vitamin E—(b3) and vitamin K—(b4).

In an embodiment, the liquid composition comprises or consists of an ethoxylated soya oil and/or an ethoxylated soya; or at least an ethoxylated fatty acid derived from soya oil and at least a vitamin (b), and water.

The method for preparing the liquid composition contemplates some operational steps.

In a first step, said at least a fat-soluble vitamin selected from the group comprising or, alternatively, consisting of vitamin A—(b1), vitamin D or vitamin D₃—(b2), vitamin E—(b3) and vitamin K—(b4), or mixtures thereof is added with a soya derivative (a) selected from the group comprising or, alternatively consisting of (a0), (a1), (a2), (a3) (a4), or (a5), in a weight ratio of soya derivative:vitamins comprised from 1:5 to 5:1, preferably comprised from 1:3 to 3:1, for example 1:1.

The soya derivative, when in ethoxylated form, contains from 20 to 80 ethyleneoxy groups; preferably from 25 to 60 ethyleneoxy groups; even more preferably from 30 to 50 ethyleneoxy groups. Advantageously, the ethoxylated fatty acid of soya oil contains from 30 to 45 ethyleneoxy groups, for example 40. Advantageously, 2, or 4, or 6, or 8, or 10, or 12, or 14, or 16, or 18, or 20, or 22, or 24, or 26, or 28, or 30 ethyleneoxy groups (which are to be understood as average ethoxylation values) are contained. The addition and mixing are carried out at a temperature comprised from 15 to 30° C., preferably from 20 to 25° C. The mixing is carried out within a period comprised from 5 to 30 minutes, preferably from 10 to 20 minutes.

Following to the mixing, a clear and transparent product is obtained, which is heated and, preferably, kept under stirring at a temperature comprised from 35 to 50° C., preferably from 40 to 45° C. The product does not change its appearance and stays clear and transparent.

Next, the above product, preferably kept under stirring, is added to the water, preferably under stirring, in a weight ratio comprised from 1:4 to 4:1, preferably from 1:3 to 3:1, even more preferably from 2:3 to 3:2, at a temperature comprised from 35 to 50° C. within a period comprised from 10 to 40 minutes, preferably from 15 to 30 minutes.

In another embodiment, the above product, preferably kept under stirring, is added to an aqueous solution, previously prepared, comprising or consisting of water, a selenium salt and polyethyleneglycol (PEG).

The selenium salt can be sodium or potassium selenite and is added in an amount by weight comprised from 0.03 to 0.3%, preferably from 0.08 to 0.12%, relative to the amount by weight of water being present in said solution; or in an amount by weight comprised from 0.01 to 0.1%, preferably from 0.02 to 0.06%, relative to the amount by weight of water being present in said solution. In an embodiment 45% sodium selenite is used.

The polyethyleneglycol (PEG) is selected from the group comprising PEG 100, PEG 200, PEG 300, PEG 600, PEG 800 or PEG 1000. In an embodiment PEG 200 is used.

The PEG is added in an amount comprised from 2 to 10%, relative to the amount by weight of water being present in said solution; preferably in an amount comprised from 4 to 6%, relative to the amount by weight of water being present in said solution; or in an amount by weight comprised from 0.5 to 3%, preferably from 1 to 2%, relative to the amount by weight of water being present in said solution. The PEG addition helps to keep and/or obtain the transparency and clearness.

In an embodiment 45% sodium selenite, polyethyleneglycol (PEG 200) and water are used.

The above product, preferably kept under stirring, is added to said aqueous solution, preferably under stirring, in a weight ratio comprised from 1:4 to 4:1, preferably from 1:3 to 3:1, even more preferably from 2:3 to 3:2, at a temperature comprised from 35 to 50° C. within a period comprised from 10 to 40 minutes, preferably from 15 to 30 minutes.

Notably, the above product is added to the water or said aqueous solution at the same temperature which is comprised from 35 to 50° C., preferably from 40 to 45° C.

Notably, the HLB value (Hidrophilic-Lipophilic-Balance) of the soya derivative (a), selected from the ethoxylated ones such as (a0), (a2) and (a4), is a value comprised from 5 to 20, preferably from 10 to 16, even more preferably from 12 to 14.

Following to the method, the liquid composition of the present invention is obtained, which is stable and has a water content greater than 10%; the water content is greater than 15%. The water content is comprised from 20 to 40%, preferably from 25 to 35% of water, relative to the amount by weight of the final liquid composition.

The liquid composition of the present invention can be suitably used in animal nutrition as such, added to the nutrients, as powder or granules or to the feed or drinking water.

The liquid composition can be added to the feed through any one of the following ways:

(i) If the liquid composition is pelletized, the liquid composition can be added to the feed before or after the pelletizing step.

(ii) The feed can be pelletized and then cooled down at a temperature comprised from 20 to 40° C., preferably from 25 to 30°, prior to adding the liquid composition.

(iii) The liquid composition can be sprayed over the feed or pellet, by using procedures and equipment known to the skilled in the field.

In the case that the liquid composition is added to the water for the animals, this addition is carried out by using known equipment.

### EXPERIMENTAL PART

The Applicant conducted experimental tests by using the following compounds:

1) Ethoxylated Fatty Acids Derived from Soya Oil (a4), Having an Ethoxylation Degree of:

i) 2 moles (2 moles of ethylene oxide (EO) units that, on average, are present in the ethoxylated soya derivative (a4) in the form of EO block).

ii) 4 moles (4 moles of ethylene oxide (EO) units that, on average, are present in the ethoxylated soya derivative (a4) in the form of EO block).

iii) 6 moles (6 moles of ethylene oxide (EO) units that, on average, are present in the ethoxylated soya derivative (a4) in the form of EO block).

iv) 8 moles (8 moles of ethylene oxide (EO) units that, on average, are present in the ethoxylated soya derivative (a4) in the form of EO block).

v) 10 moles (10 moles of ethylene oxide (EO) units that, on average, are present in the ethoxylated soya derivative (a4) in the form of EO block).

vi) 12 moles (12 moles of ethylene oxide (EO) units that, on average, are present in the ethoxylated soya derivative (a4) in the form of EO block).

vii) 14 moles (14 moles of ethylene oxide (EO) units that, on average, are present in the ethoxylated soya derivative (a4) in the form of EO block).

viii) 16 moles (16 moles of ethylene oxide (EO) units that, on average, are present in the ethoxylated soya derivative (a4) in the form of EO block).

ix) 18 moles (18 moles of ethylene oxide (EO) units that, on average, are present in the ethoxylated soya derivative (a4) in the form of EO block).

x) 20 moles (20 moles of ethylene oxide (EO) units that, on average, are present in the ethoxylated soya derivative (a4) in the form of EO block).

2) The Fat-Soluble Vitamins being Tested were:
vitamin A, D₃, E and K all of them at 95% (taken alone).
vitamin A+D₃, vitamin A+E, vitamin A+K.
vitamin A+D₃+E.

3) Soya Derivatives being Tested (a0), (a2) and (a4).

By using the method disclosed above, a liquid composition of the present invention having the following characteristics has been prepared:
20 grams of vitamin E+20 grams of ethoxylated fatty acids derived from soya oil (a4); temperature 40° C. and mixing time of 10 minutes for yielding 40 grams of a clear and transparent product.
40 grams of product (T 40° C.)+aqueous solution (T40° C.) [water 57.5 grams+2.45 grams of PEG 200+0.05 grams of sodium selenite] for yielding the liquid composition.

The liquid composition being obtained is stable and nearly clear. Quite similar results have been obtained with liquid compositions by using the soya derivative (a4), set forth above from (i) to (x), with vitamin A and vitamin K.

1. A liquid composition comprising
a soya derivative selected from:
polyethyleneglycol esters of fatty acids derived from soya oil-additive E487,
an ethoxylated soya oil and/or an ethoxylated soy, and
at least an ethoxylated fatty acid derived from soya oil, or a mixture thereof;
at least a fat-soluble vitamin selected from:
vitamin A,
vitamin D or D₃,
vitamin E, and
vitamin K, or a mixture thereof;
and
water.

2. The composition according to claim 1, wherein said soya derivative is in an ethoxylated form and contains from 1 to 200 ethyleneoxy groups.

3. The composition according to claim 1, wherein said composition comprises a water amount greater than 15% by weight relative to the amount by weight of the liquid composition.

4. The composition according to claim 1, wherein the soya derivative and said at least a fat-soluble vitamin are in a weight ratio from 1:5 to 5:1.

5. The composition according to claim 1, further comprising a selenium salt and a polyethyleneglycol PEG selected from PEG 100, PEG 200, PEG 300, PEG 600, PEG 800 or PEG 1000.

6. A method for preparing the liquid composition according to claim 1, said method comprising:
adding said at least a fat-soluble vitamin to said soya derivative, in a weight ratio of soya derivative:vitamins from 1:5 to 5:1 to yield a clear product;
adding the clear product, to water in a weight ratio from 1:4 to 4:1 to yield the liquid composition.

7. The method according to claim 6, wherein adding said at least a fat-soluble vitamin to said soya derivative is performed at a temperature from 15 to 30° C., within a period from 5 to 30 minutes.

8. A method to provide animal nutrition, the method comprising:
adding the liquid composition according to claim 1 to nutrients, or to an animal feed or to drinking water.

9. The composition according to claim 2, wherein said soya derivative contains from 1 to 80 ethyleneoxy groups.

10. The composition according to claim 3, wherein the water is in an amount from 20 to 40%, relative to the amount by weight of the liquid composition.

11. The composition according to claim 4, wherein the weight ratio is from 1:3 to 3:1.

12. The composition according to claim 5, wherein the selenium salt is sodium selenite.

13. The composition according to claim 5, wherein the polyethyleneglycol PEG is PEG 200.

14. The method according to claim 6, wherein the weight ratio of soya derivative:vitamins is from 1:3 to 3:1.

15. The method according to claim 7, wherein the vitamin and soya derivative are added at a temperature from 20 to 25° C., within a period from 10 to 20 minutes.

16. The method according to claim 6, wherein the clear product is kept under stirring and adding the clear product is performed under stirring.

17. A method for preparing the liquid composition according to claim 1, the method comprising:
adding said at least a fat-soluble vitamin to said soya derivative, in a weight ratio of soya derivative:vitamins from 1:5 to 5:1 to yield a clear product;
adding the clear product to an aqueous solution comprising water, a selenium salt and polyethyleneglycol (PEG), to yield the liquid composition.

18. The method according to claim 17, wherein the clear product is kept under stirring and adding the clear product is performed under stirring.

19. The method according to claim 17, wherein adding said at least a fat-soluble vitamin to said soya derivative is performed at a temperature from 15 to 30° C., within a period from 5 to 30 minutes.
